(19) United States
(12) Patent Application Publication
(10) Pub. No.: US 2024/0426160 A1
(43) Pub. Date: Dec. 26, 2024

(54) POWER ACTUATION OF DOORS OR TAILGATE ON AUTOMOBILE

(71) Applicant: AEHRA, Inc., Houston, TX (US)

(72) Inventor: Franco Cimatti, Pavullo nel Frignano (MO) (IT)

(21) Appl. No.: 18/747,176

(22) Filed: Jun. 18, 2024

Related U.S. Application Data
(60) Provisional application No. 63/509,382, filed on Jun. 21, 2023.

(51) Int. Cl. E05F 15/73

(52) U.S. Cl. CPC E05F 15/73; E05F 2015/767; E05Y 2900/531; E05Y 2900/546

(57) ABSTRACT

A system and method for power actuation of doors or tailgate of a vehicle uses sensed information from sensors (e.g., ultrasonic sensors, proximity sensors) and cameras to provide a space map around the vehicle and indicate whether or how far the doors and/or tailgate can open (or close) without colliding with objects surrounding the vehicle (e.g., walls, ceiling, garage door, other vehicles, individuals).

### INCORPORATION BY REFERENCE TO ANY PRIORITY APPLICATIONS

This application claims the benefit of U.S. Provisional Application No. 63/509,382, entitled “POWER ACTUATION OF DOORS OR TAILGATE ON AUTOMOBILE” and filed on Jun. 21, 2023, which is hereby incorporated by reference herein in its entirety.

### BACKGROUND

### Field

The present disclosure is directed to an automobile and more particularly to power actuation of doors and/or tailgate of automobile.

### Description of the Related Art

Automobiles typically allow the manual opening of doors. Some vehicles allow the power opening of a trunk or tailgate. Doors and tailgates can open to a fully opened position. In some instances, the trunk or tailgate can be programmed to open to a particular position. However, depending on how far the doors or tailgate are designed to open, and the space available around the vehicle (e.g., in a garage, parking lot), the doors or tailgate can collide with objects (e.g., ceiling, garage door, adjacent wall or vehicle) when opened.

### SUMMARY

In accordance with one aspect of the disclosure, a system and method for power actuation is provided, where the opening and/or closing actuation of the doors based at least in part on sensed information from sensors and cameras of the vehicle that provide a space map around the vehicle and indicate whether or how far the doors and/or tailgate can open (or close) without colliding with objects surrounding the vehicle (e.g., walls, ceiling, garage door, other vehicles, individuals).

In accordance with another aspect of the disclosure, a system for operating the opening or closing or doors or a tailgate of an automobile is provided. The system comprises one or more sensors of the automobile, one or more cameras of the automobile and a computer processor in communication with the one or more sensors and the one or more cameras. The computer processor is configured to: receive sensed information from the one or more sensors or the one or more cameras, generate a space map of an area around the automobile within which one or more doors or a tailgate of the automobile can move without colliding with an object, determine whether the one or more doors or tailgate can open or close without colliding with an object, and control an actuation of the one or more doors or tailgate of the automobile to a) move within the space map or b) not move if it is not possible to do so without colliding with an object.

In some aspects, the one or more sensors can include one or more proximity sensors. In some cases, the one or more sensors can include one or more ultrasonic sensors. The object can be a person, a ceiling, a garage door, a wall, or another automobile. In some cases, actuation of the one or more doors or tailgate can include a powered actuation of the one or more doors or tailgate. In some aspects, the system further includes a remote in communication with the computer processor, the remote configured to selectively operate actuation of the one or more doors or tailgate of the automobile. The remote can communicate with the computer processor wirelessly. In some cases, in response to the remote being pressed once, the computer processor controls actuation of the one or more doors or tailgate of the automobile to a) move within the space map or b) not move if the computer processor determines it is not possible to do so without colliding with the object. In some aspects, in response to the remote being actively pressed, the computer processor moves the one or more doors or tailgate of the automobile irrespective of a proximity of the object. The system can further include a user interface in communication with the computer processor. The computer processor can be configured to generate a visual representation of the space map. The user interface can be configured to display the visual representation of the space map.

In accordance with another aspect of the disclosure, a method for operating the opening or closing of doors or tailgate of an automobile is provided. The method comprises the steps of: receiving with a computer processor sensed information from one or more sensors or one or more cameras of an automobile, generating a space map of an area around the automobile within which one or more doors or a tailgate of the automobile can move without colliding with an object, determining whether the one or more doors or tailgate can open or close without colliding with an object, and controlling an actuation of the one or more doors or tailgate of the automobile to a) move within the space map or b) not move if it is not possible to do so without colliding with an object.

In some aspects, receiving with a computer processor sensed information from one or more sensors includes receiving sensed information from one or more ultrasonic sensors. In some cases, receiving with a computer processor sensed information from one or more sensors includes receiving sensed information from one or more proximity sensors. The object is a person, a ceiling, a garage door, a wall, or another automobile. In some aspects, controlling an actuation of the one or more doors or tailgate of the automobile includes powering via one or more motors the actuation of the one or more doors or tailgate.

In accordance with another aspect of the disclosure, a computer executable code stored in a computer readable memory is provided. When executed by a computer processor the computer executable code is configured to cause the computer processor to: receive sensed information from one or more sensors or one or more cameras of an automobile, generate a space map of an area around the automobile within which one or more doors or a tailgate of the automobile can move without colliding with an object, determine whether the one or more doors or tailgate can open or close without colliding with an object, and control an actuation of the one or more doors or tailgate of the automobile to a) move within the space map or b) not move if it is not possible to do so without colliding with an object.

In some aspects, the one or more sensors can include one or more proximity sensors. In some cases, the one or more sensors include one or more ultrasonic sensors. Actuation of the one or more doors or tailgate can include a powered actuation of the one or more doors or tailgate. In some aspects, the system is further configured to cause the computer processor to generate a visual representation of the space map and display the visual representation of the space map on a user interface.

### BRIEF DESCRIPTION OF THE DRAWINGS

FIG. 1 is a side view of a vehicle with doors in a fully opened position.

FIG. 2 is a side view of the vehicle showing the motion of the doors when opening to the fully opened position.

FIG. 3 is a side view of the vehicle showing the motion of the doors when opening to the fully opened position and the tailgate in the fully opened position.

FIG. 4 is a side view of the vehicle showing the motion of the doors when opening to the fully opened position and the tailgate in the fully opened position, and a space map surrounding the doors and tailgate.

FIG. 5A is a schematic diagram of the power actuation system of the automobile.

FIG. 5B is another example of a schematic diagram of the power actuation system of the automobile.

FIG. 6 is a side view of a vehicle with a plurality of actuators.

### DETAILED DESCRIPTION

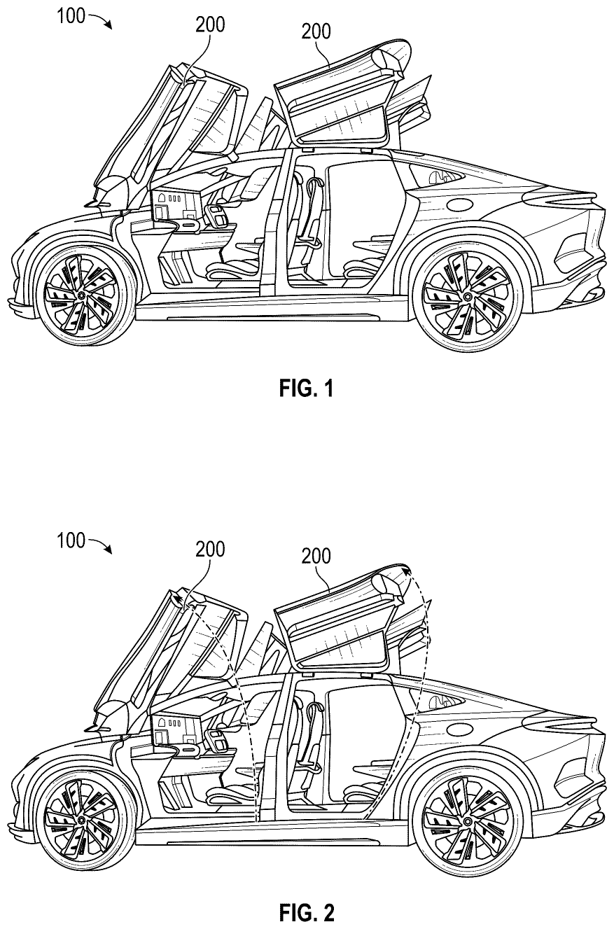

FIGS. 1-4 show a vehicle 100. The vehicle 100 can include one or more doors and/or a tailgate. For example, the vehicle 100 can include four doors 200. The vehicle 100 can be an electric vehicle. Although reference is made to the vehicle 100 being electric, any of the disclosures herein can be applied to a non-electric vehicle. In some cases, the doors 200 can be dihedral doors. For example, the doors 200 can open in the manner shown in FIG. 2. As described in further detail below, each door 200 can open outwards and upwards (e.g., following a curved path) relative to a hinge. In some cases, each door 200 can include an actuator (e.g., electronic actuator, electromechanical actuator). The actuator can beneficially allow for automatic opening and/or closing of each door 200.

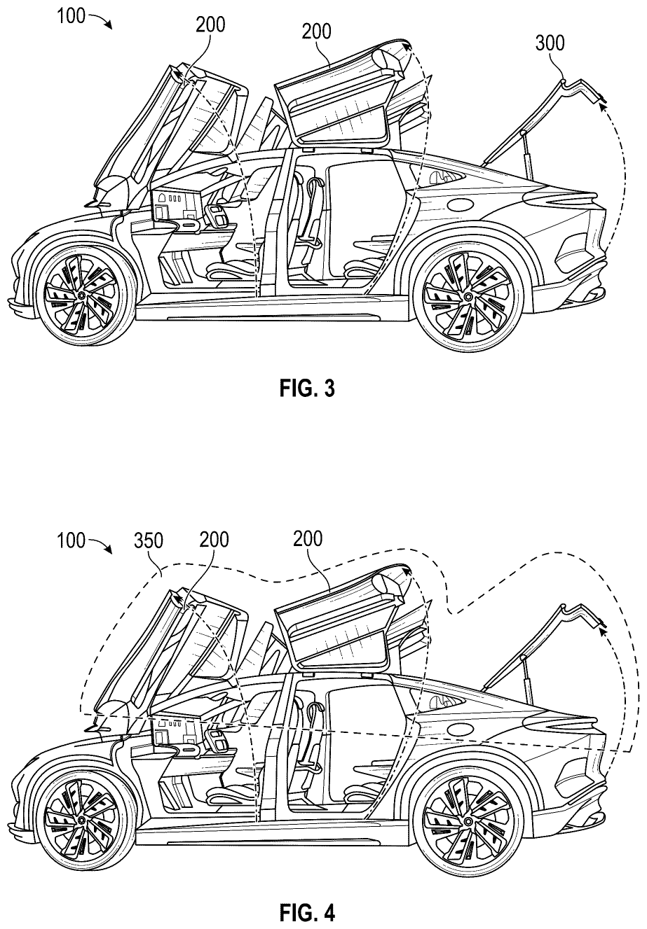

The vehicle 100 can also include a tailgate 300. The tailgate 300 can open as shown in FIG. 3. For example, the tailgate 300 can open upward relative to one or more hinges. The tailgate can include one or more actuators (e.g., electronic actuator, electromechanical actuator). The one or more actuators can beneficially allow for automatic opening and/or closing of the tailgate 300.

FIG. 4 shows a space map 350 surrounding the vehicle 100 to indicate whether and/or by how much the doors 200 can be opened or closed without colliding with surrounding objects (e.g., ceiling, walls, other cars, individuals). As further described below, the vehicle 100 can include one or more sensors. The one or more sensors can be configured to detect whether an object is positioned within and/or adjacent to the space map 350. In response to detecting that an object is positioned within and/or adjacent to the space map 350, the one or more sensors can prevent the opening and/or closing of a door 200 and/or the tailgate 300. In some cases, the one or more sensors may allow a door 200 to at least partially open (e.g., allow the door to open to less than its full opening span, to not fully open) and/or close (e.g., allow the door to not fully close) even when an object is within and/or adjacent to the space map 350. In such cases, the one or more sensors may limit the range of motion of a door 200 and/or the tailgate 300 to allow for partial opening and/or closing while preventing collision with the detected object. The use of sensors can beneficially prevent the doors 200 and/or the tailgate 300 from colliding with adjacent object and/or closing on the object.

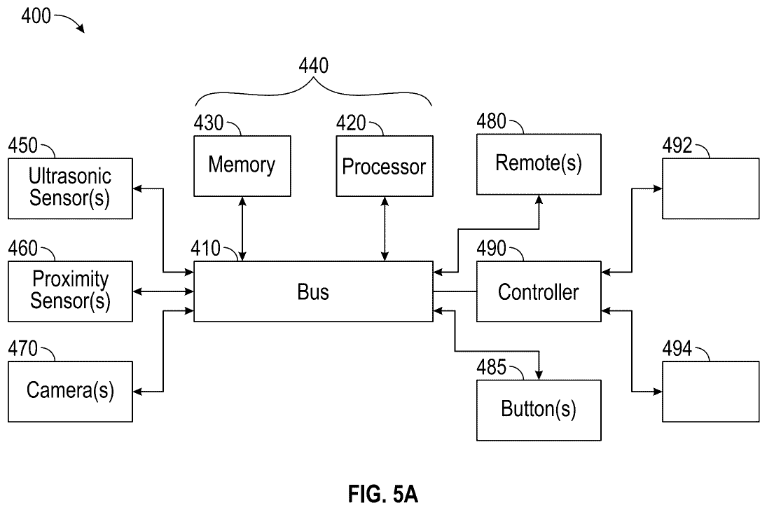

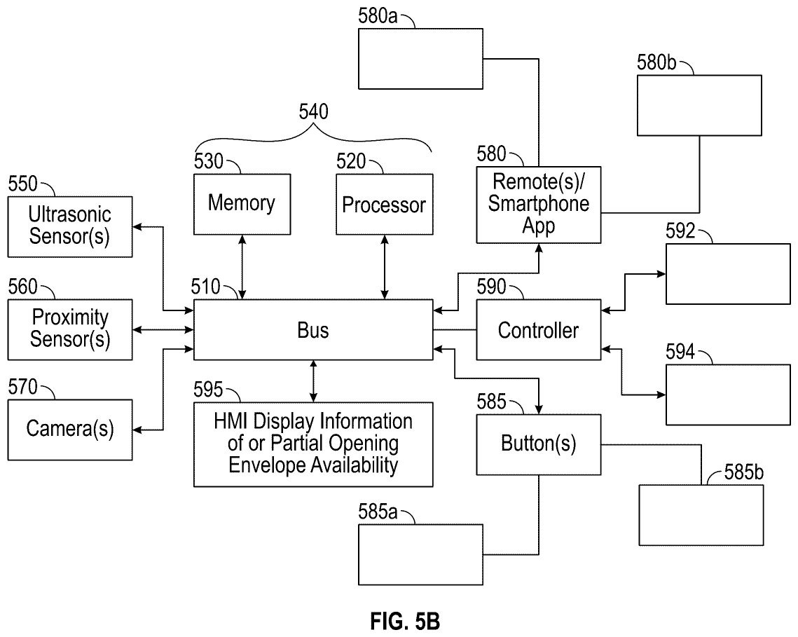

FIG. 5A is a block diagram illustrating a processing system 400 for power actuation of each of the doors 200 and/or the tailgate 300. The processing system 400 can include a bus 410 or other communication mechanism for communicating information. The processing system 400 can also include a computing unit 440. The computing unit 440 can include a processor 420 (e.g., one or more, multiple, computer processors) and/or a memory 430 (e.g., one or more, multiple, memory modules). The computing unit 440 can be in communication with the bus 410. For example, the bus 410 can receive data from and/or send data to the computing unit 440. Each of the processor 420 and/or the memory 430 can receive data from and/or send data to the bus 410.

The processor 420 can process data and/or execute instructions. For example, the processor 420 can process data and/or execute instructions to effect power actuation (e.g., closing, opening) of the doors 200 and/or the tailgate 300 as described herein. The memory 430 can store information and/or instructions to be executed by the processor 420. For example, the memory 430 can store information and/or instructions for effecting actuation of the doors 200 and/or the tailgate 300 discussed herein.

The bus 410 can be in communication with or more vehicle components such as sensors, cameras, and/or actuators of the vehicle 100. For example, the bus 410 can be in communication with one or more ultrasonic sensors 450, one or more proximity sensors 460, and/or one or more cameras 470. Each of the ultrasonic sensor(s) 450, the proximity sensor(s) 460, and/or the camera(s) 470 can detect the presence and/or position of an object relative to the vehicle 100. For example, the ultrasonic sensor(s) 450 can measure a distance of an object relative to an ultrasonic sensor(s) 450. The ultrasonic sensor(s) 450 can emit an ultrasonic wave and receive a wave reflected back from the object. The ultrasonic sensor(s) 450 may calculate the distance between the ultrasonic sensor(s) 450 and the object by measuring the time between the emission of the ultrasonic wave and reception of the reflected wave. Similarly, a proximity sensor(s) 460 may detect or sense the approach or presence of a nearby object by emitting an electromagnetic field and/or a beam of electromagnetic radiation. The proximity sensor 460(s) can look for changes in the field or return signal. The camera(s) 470 may employ object recognition technology to detect and/or sense the approach and/or a presence of an object. Although reference is made to the use of ultrasonic sensor(s) 450, proximity sensor(s) 460, and/or camera(s) 470 for detecting the approach and/or presence of an object, any sensor/or device for detecting objects can be used.

The bus 410 can receive data from the one or more ultrasonic sensors 450, the proximity sensor(s) 460 and/or the camera(s) 470 of the vehicle 100. The bus 410 can communicate the data received from the ultrasonic sensor(s) 450, the proximity sensor(s) 460 and/or the camera(s) 470 to the processor 420. The processor 420 can process the sensed information provided by one or more of the ultrasonic sensors 450, the proximity sensor(s) 460, and/or the camera(s) 470 to generate information and/or execute instructions. For example, the processor may generate the space map 350 based on the readings from the ultrasonic sensor(s) 450, the proximity sensor(s) 460, and/or the camera(s) 470. Based on the readings from the ultrasonic sensor(s) 450, the proximity sensor(s) 460, and/or the camera(s) 470, the processor 420 may also assess whether to allow actuation of the doors 200 and/or the tailgate 300 to open or close, as described herein.

In some cases, the bus 410 can be in communication with one or more remotes 480, one or more controllers 490, and/or one or more buttons 485. Communication between the bus 410 and the remote(s) 480, the controller(s) 490, and/or the button(s) 485 can be wired and/or wireless (e.g., Bluetooth, Wi-Fi, cellular, etc.). The remote(s) 480 can include a key fob and/or a smartphone application (e.g., on a smartphone or tablet computer). In some cases, the button(s) 485 can be positioned on the doors 200, the tailgate 300, and/or any other suitable position (e.g., automobile dashboard, automobile steering wheel). The controller(s) 490 can be in communication with one or more actuator(s) 492 and/or position sensor(s) 494. Each door 200 and the tailgate 300 may include an actuator 492. In some cases, each actuator 492 can include a position sensor 494. The position sensor 494 can detect the position of the actuator 492. This can beneficially allow the position sensor 494 to determine whether the a door 200 and/or the tailgate 300 is open or closed.

Actuation of the remote(s) 480 and/or the button(s) 485 can cause the doors 200 and/or the tailgate 300 to open or close. For example, actuation of the remote(s) 480 and/or the button(s) 485 can generate an actuation signal. The bus 410 can receive the actuation signal and communicate the actuation signal to the processor 420. Based on instructions stored in the memory 430, the processor may cause one or more doors 200 and/or the tailgate 300 to open and/or close in response to receiving the actuation signal.

The remote(s) 480 and/or the button(s) 485 can include more than one actuation mode. For example, the remote(s) 480 and/or the button(s) 485 can include a single touch actuation mode. According to the single touch actuation mode, a single touch (e.g., actuation, pressing, activation) of the remote(s) 480 and/or the button(s) 485 can generate an actuation signal. The actuation signal may cause a door 200 and/or the tailgate to open or close.

The remote(s) 480 and/or the button(s) 485 can also include a manual operation mode. In the manual operation mode, the remote(s) 480 and/or the button(s) 485 will generate an actuation signal for as long as the remote(s) and/or the button(s) are actively actuated. Using the button(s) 485 as an example, an actuation signal will be generated only when a button(s) 485 are held in a pressed position (e.g., when a user touches or depresses the button(s) 485). When the remote(s) 480 and/or the button(s) 485 are actively actuated, the doors 200 and/or the tailgate 300 may open and/or close and may stop opening and/or closing when the remote(s) 480 and/or the button(s) 485 stop being actuated. In the manual operation mode, actuation of the remote(s) 480 and/or the button(s) 485 may override the object detection systems described herein. That is, in the manual operation mode, actuation of the remote(s) 480 and/or the button(s) 485 may cause the doors 200 and/or the tailgate 300 to open and/or close even when, as described below, the ultrasonic sensor(s) 450, the proximity sensor(s) 460, and/or the camera(s) 470, have detected an object or obstacle. In the manual operation mode, the speed at which the doors 200 and/or the tailgate open may be slower than that of the single touch actuation mode. The reduced speed can beneficially provide additional reaction time to users.

In some cases, the sensing data from the ultrasonic sensor(s) 450, the proximity sensor(s) 460, and/or the camera(s) 470, may prevent and/or limit actuation of the doors 200 and/or the tailgate 300 even when the remote(s) 480 and/or a button(s) 485 are actuated. For example, if a door 200 and/or the tailgate is closed and an actuation signal is generated, the processor 420 may prevent opening of and/or limit the range of motion of the door 200 and/or the tailgate 300 if any of the ultrasonic sensor(s) 450, the proximity sensor(s) 460, and/or the camera(s) 470 detect the presence of an object adjacent to the door 200 and/or the tailgate 300. This can prevent the door 200 and/or the tailgate 300 from colliding with the object which can beneficially prevent damage to the door 200 and/or the tailgate 300 and/or prevent injuries. As another example, if a door 200 and/or the tailgate is open and an actuation signal is generated, the processor 420 may prevent closing of and/or limit the range of motion of the door 200 and/or the tailgate 300 if any of the ultrasonic sensor(s) 450, the proximity sensor(s) 460, and/or the camera(s) 470 detect the presence of an object adjacent to the door 200 and/or a tailgate 300. This can prevent the door 200 and/or the tailgate 300 from colliding with the object and/or trapping the object between the door 200 and/or the tailgate and the body of the vehicle 100. As further described herein, in some cases opening and/or closing of a door 200 and/or the tailgate 300 may be prevented or limited if an object is detected within the space map 350.

The processing system 400 can provide instructions to the controller(s) 490 of one or more of the doors 200 and tailgate 300 to allow, prevent, and/or limit (e.g., limit the travel of) opening and/or closing of the doors 200 and/or the tailgate 300 (e.g., via power actuation). In some cases, the controller(s) 490 of the system 400 provide for full power actuation in opening and/or closing of the doors 200 and/or the tailgate 300 (e.g., without requiring any manual force applied by the user on the doors 200 or tailgate 300 to open or close them). In some cases, the controller(s) 490 of the system 400 provide for partial power actuation in opening and/or closing of the doors 200 and/or tailgate 300 (e.g., requiring some manual force applied by the user on the doors 200 or tailgate 300 to open or close them).

In operation, a user can provide an actuation signal (e.g., via a remote(s) 480, such as a key fob, or a button or lever 485 on the inside or outside of the automobile) to open one or more of the doors 200 and/or the tailgate 300. The bus 410 can receive sensed information from the ultrasonic sensor(s) 450, the proximity sensor(s) 460, and/or the camera(s) 470, and generate a space map 350 identifying the space within which the doors 200 and/or the tailgate 300 can be safely moved without colliding with a person or object (e.g., ceiling, garage door, wall, other cars). The processor 420 can control the opening or closing of the doors 200 and/or the tailgate 300 via the controller 490 so that the doors 200 and/or the tailgate 300 stay within the space map (e.g., while opening), such as by limiting the extent to which the doors 200 and/or the tailgate 300 can move and/or extend outwards and upwards (e.g., the extent to which the doors 200 and/or the tailgate 300 can open, the extent to which the doors 200 and/or the tailgate 300 can close).

The controller 490 can control the powered actuation of the doors 200 and/or the tailgate 300. For example, the controller 490 can control the operation of one or more motors that drive the opening and/or closing of the doors 200 and/or the tailgate 300. In some cases, the motors can be electric motors. In some cases, when the processor 420 determines that the doors 200 and/or the tailgate 300 cannot open or close without colliding with an object (e.g., a person, other car, a wall, a ceiling), the processor 420 can inhibit (e.g., prevent) the doors 200 or tailgate 300 from opening. In some cases, the processor 420 can prevent and/or limit opening and/or closing of the doors 200 and/or the tailgate 300 until the generated space map 350 indicates sufficient space is available to open the doors 200 and/or tailgate 300. The processor 420 can also provide a collision alert (e.g., audible and/or visual alert) to the user.

FIG. 5B another example of a block diagram illustrating a processing system 500 for power actuation of each of the doors 200 and/or the tailgate 300. The processing system 500 can include some or all of the components of the processing system 400. For example, the processing system 500 can include a bus 510, a computing unit 540, one or more ultrasonic sensors 550, one or more proximity sensors 560, one or more cameras 570, one or more remotes 580, one or more buttons 585, and/or a controller 590. The computing unit 540 can include a processor 520 and a memory 530. The controller 590 can be in communication with one or more actuators 592 and/or position sensors 594. The processing system 500 can also include a display 595 in communication with the bus 510.

The display 595 can include a human machine interface (HMI) display. In some cases, the display can be integrated into the vehicle 100. For example, the display 595 may be integrated into a central console of the vehicle 100. The display 595 can beneficially display information relating to the operation of the vehicle 100 and/or the processing system 500. In some cases, the display 595 may include information relating to the position and/or operation of the doors 200 and/or the tailgate 300. For example, the display 595 may display a visual representation of the vehicle 100 showing the position of the doors 200 and/or the tailgate 300. The visual representation of the vehicle 100 in the display 595 may show how the doors 200 and/or the tailgate 300 open and/or close. In some cases, the display 595 may display the space map 350. This can beneficially allow users to identify objects that may be positioned within the space map 350 and/or the available range of motion for each door 200 and/or the tailgate 300.

The remote(s) 580 can include one or more controls. For example, the remote(s) 580 can include a first control 580a and a second control 580b. In some cases, the first control 580a and the second control 580b can be associated with an actuation mode. For example, the first control 580a can be a first button 580a associated with the single touch actuation mode and the second control 580b can be a second button 580b associated with the manual operation mode. Thus, actuating and/or pressing the first button 580a once can cause the doors 200 and/or the tailgate 300 to open and/or close. The second button 580b may cause the doors 200 and/or the tailgate 300 to open or close only while the second button 580b is actively pressed and/or actuated.

The button(s) 585 can include a first button 585a and a second button 585b. In some cases, the first button 585a and the second button 585b can be associated with an actuation mode. For example, the first button 585a can be associated with the single touch actuation mode and the second button 585b can be associated with the manual operation mode. Thus, actuating and/or pressing the first button 585a once can cause the doors 200 and/or the tailgate 300 to open and/or close. The second button 585b may cause the doors 200 and/or the tailgate 300 to open or close only while the second button 585b is actively pressed and/or actuated.

Although reference is made to the systems 400 and 500 being able to detect objects and/or obstacles when opening and/or closing the doors 200 and/or the tailgate 300, the present description contemplates a dynamic system in which the unobstructed space around the vehicle is constantly updated. For instance, the systems 400 and 500 can adjust the space map 350 when, for example, the vehicle is stationary, the vehicle is in motion, an object or person approaches the vehicle, and/or the surroundings of the vehicle change (e.g., a garage door is opened or closed).

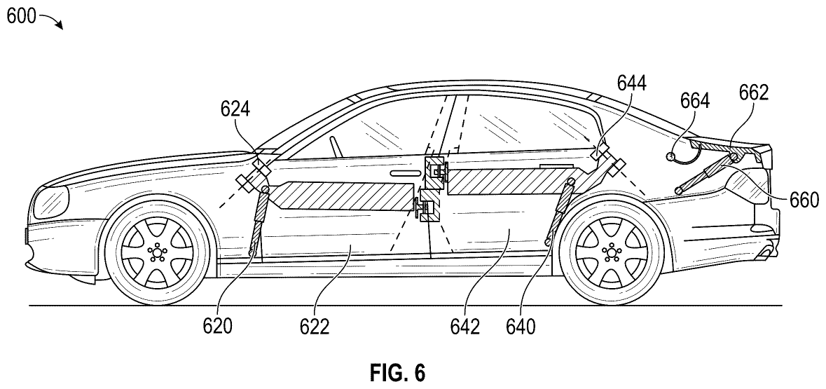

A shown in FIG. 6, a vehicle 600, which can be similar or identical to the vehicle 100, can include a plurality of actuators and/or hinges. For example, the vehicle can include a front door actuator 620, a rear door actuator 640, and/or a tailgate actuator 660. The vehicle 600 can include a front door actuator 620 for each front door 622, and a rear door actuator 640 for each rear door 642. The front door actuator 620 can be attached to the front door 622, the rear door actuator can be attached to the rear door 642, and the tailgate actuator 660 can be secured to a tailgate 662. The front door 622, the rear door 642, and the tailgate 662 can be secured to the vehicle 600 via hinges 624, 644, and 664 respectively. When the actuators are activated, the doors 622, 642 and/or the tailgate 662 can move relative to the hinges 624, 644, and 664, respectively. As way of example, the front door 622 and the rear door 642 can move outwards and upwards relative to the hinges 624 and 644, respectively. In some cases, each of the front door actuator 620, the rear door actuator 640, and the tailgate actuator 660, can include one or more sensors. For example, each actuator can include a travel sensor and/or a position sensor. The actuators 6520, 640, 660 can in one example be electronic actuators (e.g., electric motor driven actuators, such as electro-pneumatic actuators or electro-hydraulic actuators).

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed automobile.

What is claimed is:

1. A system for operating opening or closing doors or a tailgate of an automobile, comprising:
one or more sensors of the automobile;
one or more cameras of the automobile; and
a computer processor in communication with the one or more sensors and the one or more cameras, the computer processor configured to:
receive sensed information from the one or more sensors or the one or more cameras,
based on the sensed information, generate a space map of an area around the automobile within which one or more doors or a tailgate of the automobile can move without colliding with an object,
determine whether the one or more doors or tailgate can open or close without colliding with an object, and
control an actuation of the one or more doors or tailgate of the automobile to a) move within the space map or b) not move if it is not possible to do so without colliding with an object.

2. The system of claim 1, wherein the one or more sensors comprise one or more proximity sensors.

3. The system of claim 1, wherein the one or more sensors comprise one or more ultrasonic sensors.

4. The system of claim 1, wherein the object is a person, a ceiling, a garage door, a wall, or another automobile.

5. The system of claim 1, wherein said actuation of the one or more doors or tailgate comprises a powered actuation of the one or more doors or tailgate.

6. The system of claim 1, further comprising a remote in communication with the computer processor, the remote configured to selectively operate actuation of the one or more doors or tailgate of the automobile.

7. The system of claim 6, wherein and the remote communicates with the computer processor wirelessly.

8. The system of claim 6, wherein in response to the remote being pressed once, the computer processor controls actuation of the one or more doors or tailgate of the automobile to a) move within the space map or b) not move if the computer processor determines it is not possible to do so without colliding with the object.

9. The system of claim 6, wherein in response to the remote being actively pressed, the computer processor moves the one or more doors or tailgate of the automobile irrespective of a proximity of the object.

10. The system of claim 1, further comprising a user interface in communication with the computer processor, the computer processor configured to generate a visual representation of the space map, and the user interface configured to display the visual representation of the space map.

11. A method for operating opening or closing doors or tailgate of an automobile, comprising:
receiving with a computer processor sensed information from one or more sensors or one or more cameras of an automobile;
generating a space map of an area around the automobile within which one or more doors or a tailgate of the automobile can move without colliding with an object;
determining whether the one or more doors or tailgate can open or close without colliding with an object; and
controlling an actuation of the one or more doors or tailgate of the automobile to a) move within the space map or b) not move if it is not possible to do so without colliding with an object.

12. The method of claim 11, wherein receiving with a computer processor sensed information from one or more sensors comprises receiving sensed information from one or more ultrasonic sensors.

13. The method of claim 11, wherein receiving with a computer processor sensed information from one or more sensors comprises receiving sensed information from one or more proximity sensors.

14. The method of claim 11, wherein the object is a person, a ceiling, a garage door, a wall or another automobile.

15. The method of claim 11, wherein controlling an actuation of the one or more doors or tailgate of the automobile comprises powering via one or more motors the actuation of the one or more doors or tailgate.

16. A computer executable code stored in a computer readable memory, that when executed by a computer processor is configured to cause the computer processor to:
receive sensed information from one or more sensors or one or more cameras of an automobile;
generate a space map of an area around the automobile within which one or more doors or a tailgate of the automobile can move without colliding with an object;
determine whether the one or more doors or tailgate can open or close without colliding with an object; and
control an actuation of the one or more doors or tailgate of the automobile to a) move within the space map or b) not move if it is not possible to do so without colliding with an object.

17. The computer executable code defined in claim 16, wherein the one or more sensors comprise one or more proximity sensors.

18. The computer executable code defined in claim 16, wherein the one or more sensors comprise one or more ultrasonic sensors.

19. The computer executable code as defined in claim 16, wherein said actuation of the one or more doors or tailgate comprises a powered actuation of the one or more doors or tailgate.

20. The computer executable code as defined in claim 16, further configured to cause the computer processor to generate a visual representation of the space map and display the visual representation of the space map on a user interface.
